(19) United States
(12) Patent Application Publication
(10) Pub. No.: US 2012/0208107 A1
(43) Pub. Date: Aug. 16, 2012

(54) ELECTRODE FOR A MOLTEN CARBONATE FUEL CELL AND METHOD FOR THE PRODUCTION THEREOF

(75) Inventors: Marc Bednarz, Taufkirchen (DE); Ursula Paulus-Rodatz, Landshut (DE); Helga Strohl, Munich (DE)

(73) Assignee: MTU Friedrichshafen GmbH, Friedrichshafen (DE)

(21) Appl. No.: 13/390,300

(22) PCT Filed: Aug. 9, 2010
(86) PCT No.: PCT/EP10/04868

§ 371 Date: May 4, 2012

(30) Foreign Application Priority Data
Aug. 13, 2009 (DE) 10 2009 037 425.6
Oct. 22, 2009 (DE) 10 2009 050 435.4

(51) Int. Cl. H01M 4/86; B05D 5/12

(52) U.S. Cl. 429/534; 429/532; 427/115

(57) ABSTRACT

The invention relates to an electrode for a molten carbonate fuel cell, having an electrode framework and an active layer comprising pores which is applied to the electrode framework. According to the invention, the active layer contains at least one structure stabilizer. The invention also relates to a method for producing said type of electrode.

### CROSS-REFERENCE TO RELATED APPLICATIONS

This application claims priority to German patent applications DE 10 2009 037 425.6 filed on Aug. 13, 2009, DE 10 2009 050 435.4 filed on Oct. 22, 2009 and PCT application PCT/EP2010/004868 filed on Aug. 9, 2010, which are hereby incorporated by reference in their entireties.

### TECHNICAL FIELD

The present invention relates to an electrode for a molten carbonate fuel cell with an electrode structure and with an active layer with pores applied to the electrode structure. The present invention further relates to a method for producing such a molten carbonate fuel cell, whereby an active layer is produced from a compound that contains at least one active substance, at least one pore-forming substance, and at least one binding agent, and whereby the mixture is then applied to an electrode structure and the resulting green compact heated, so that at least one pore-forming substance and at least one binding agent are burned off.

### BACKGROUND

Fuel cells are primary cells, in which there is a chemical reaction between a gas and an electrolyte. In principle, through a reversal of the electrolysis of water, a hydrogen-containing fuel gas is applied to an anode and a cathode and gas containing oxygen applied to a cathode that then reacts to form water. The released energy is extracted as electrical energy.

Molten carbonate fuel cells (MCFC) are described for example in DE 43 03 136 C1 and DE 195 15 457 C1. In their electrochemically active area, they consist of an anode, an electrolyte matrix and a cathode. A melt of one or more alkali metal carbonates that are incorporated into a finely porous electrolyte matrix serves as the electrolyte. The electrolyte separates the anode from the cathode and seals the gas spaces of the anode and cathode from one another. During operation of a molten carbonate fuel cell, the cathode is supplied with a gas mixture containing oxygen and carbon dioxide, mostly air and carbon dioxide. The oxygen is reduced and reacts with the carbon dioxide to form carbonate ions that migrate into the electrolyte. The anode is supplied with hydrogenous fuel gas, and the hydrogen is oxidized and reacts with the carbonate ions from the melt to form water and carbon dioxide. The carbon dioxide is returned to the cathode through a circuit. The oxidation of the fuel and the reduction of the oxygen take place separately from one another. The operating temperature is usually between 550° C. and 750° C. MCFC cells transform the chemical energy directly and efficiently into electrical energy.

The cathode reaction during the operation of the MCFC in which oxygen is reduced and reacts with carbon dioxide to form carbonate ions that migrate into the electrolyte, is a very complex process because the three phases of electrode, electrolyte and cathode gas are involved. Therefore, the morphology of the cathode is a key factor for an optimal cathode reaction. One aspect of the morphology of the cathode is the porosity of the active layer. In general, a bimodal pore distribution is targeted, in which pores of two different pore sizes coexist in the active layer. During operation, the larger pores (hereinafter referred to as gas transport pores) are not filled with electrolyte and serve for the gas transport within the electrode, while the electrochemical reaction takes place in the smaller pores that are filled as evenly as possible with molten electrolyte (hereinafter referred to as reaction pores).

A conventional cathode has a porous active layer of nickel oxide and is usually produced by a so-called coating process. This is a mixture of fine, powdered nickel filaments (e.g. Ni-210 from the company Inco), polymeric binders and possibly pore-forming and/or substances determining the pore size (hereinafter referred to as pore formers) that are applied to a stabilizing electrode structure, the so-called cathode foam (e.g. nickel foam made by Inco). The application rate is determined by the desired weight per unit area of the nickel cathode. The resulting so-called green compact or cathode precursor in the manufacturing state, is then assembled with other components of an MCFC cell. The cathode is conditioned when the MCFC cell is first activated and brought up to the operating temperature. This means that the polymeric binder and, as necessary, the pore former are burned off and are oxidized to form nickel oxide both in the cathode foam as well as in the active layer containing metallic nickel.

Thus, the pores are formed during the conditioning. Both the size and the volume of pores are determined. Simultaneously, the cathode undergoes a loss in thickness during the conditioning, because the cellular components are subjected to an external pressure and thus subject the overall area of the cathode to a higher pressure. This process can be measured as shrinkage of the cell during the conditioning because the cell and the cathode become thinner.

This process also reduces the pore volume, because the pores are compressed. However, this happens to varying degrees. The pores formed in the electrode structure are supported by this and largely retain their shape and size. The pores formed in the active layer are almost completely subjected to the pressure applied to the cathode and are compressed the most. This enables thickness comparisons. Following the completion of the conditioning, a new specific pore volume with a new specific pore size and a new specific relationship between the gas transport pores and the reaction pores is obtained.

The pore structure obtained following completion of the conditioning is further altered during the operation of the cathode. Due to the unchanged high pressure applied to the cell surface and due to the high temperature sintering processes, the pore structure begins to change. Here, smaller nickel oxide particles are released from their place in the filament structure upon completion of the conditioning, and larger nickel oxide particles grow at the expense of the smaller nickel oxide particles (Ostwald-effect).

Consequently, the number of larger pores increases at the expense of the number of small pores, because they are either crushed or enlarged due to the Ostwald effect. Of these, the pores formed in the electrode structure are the least affected because they are supported by this.

### SUMMARY

The object of the present invention is therefore to provide an electrode of the above-mentioned kind, whereby the desired pore sizes and pore volumes are maintained as long as possible during production and operation. The object of the present invention is also to propose a method for producing such an electrode.

The solution consists of an electrode with the features of patent claim 1 as well as a method having the features of patent claim 12. According to the invention, it is therefore intended that the active layer structure contains at least one stabilizer. The inventive method is characterized by the fact that at least one structure stabilizer is introduced into the mixture, whereby the pores resulting from the production are then stabilized in operation in volume and/or shape and/or size.

In addition to the active substance, the pore forming substance and the binding agent, there is also at least one structure stabilizer in the mix for the production of an electrode. The structure stabilizer is used to reduce the shrinkage of the active layer during conditioning and maintain the microscopic pore structure resulting from the conditioning as far as possible with respect to the volume, shape and size of the resulting pores both during conditioning and during operation. The (at least one) structure stabilizer thus acts against the external pressure acting on the cathode due to its own stability during production of the green compact, during the conditioning and during the operation. The (at least one) structure stabilizer simultaneously acts against changes in the pore structure caused by the sintering processes occurring as a result of the high temperatures that occur during operation. The structure stabilizer is therefore subject, to a lesser extent, to the temperature-dependent maturation processes.

Amazingly, it has been shown that the performance of the electrode according to the invention is improved permanently by the measures according to the invention.

The cathode according to the invention or method according to the invention are thus characterized by the fact that a greater volume of active pores is produced than could be done until now, and that these actively formed pores are maintained longer than before during operation of the cathode. Thus the high power density of the cathode and thus the performance of the entire cell stack is maintained in the long term. This also causes the life span to be significantly extended and the operable power density of the system to be increased. This causes a significant reduction in associated costs per kilowatt hour.

Advantageous developments emerge from the dependent claims.

Nickel filaments or ceramic fibers are particularly suitable as the structure stabilizer. Suitable nickel filaments preferably have particles with an average diameter of 2.2 to 3.3 μm (maximum diameter up to 6 μm). They are more stable, i.e. more dimensionally stable under the conditioning and operating conditions (i.e. temperature, pressure, and fuel gas or oxidizing atmosphere) as the active substance used for the production of the active layer, with which they are mixed according to the invention. The structure of the nickel particles of the nickel filaments of the structure stabilizer are larger in size than the nickel particles of the stabilizer of the active layer. The nickel filaments of the structure stabilizer preferably have nickel particles a minimum of 1.5 to 2 times larger in diameter than the nickel filaments of the active layer. The nickel filaments of the structure stabilizer have nickel particles having an average diameter of 2.2 to 3.3 μm up to a maximum diameter of 6 μm.

Suitable ceramic fibers may have, for example, a diameter of 3 μm to 20 μm and/or a length of 500 μm to 1000 μm.

The ratio of active material to structure stabilizer moves preferably in a range from 1:1 to 10:1 parts by weight, when nickel filaments are used as the structure stabilizer. Especially preferred mixing ratios are 7:3, 6:4 and 5:5.

When ceramic fibers are used as a structure stabilizer, the final mixture for producing the active layer should preferably have a volume fraction of 1 Vol. % to 20 Vol. %.

A suitable active substance is powdered nickel filaments having nickel particles with an average diameter of 0.5 μm to 1.0 μm up to a maximum diameter of 3.0 μm.

The active substance, the pore former, the binding agent and the structure stabilizer, can be processed in a manner known to a person skilled in the art to form an electrode slurry that is then applied to the foam.

The present invention is not limited to aqueous systems but can, for example, also be applied to systems with organic solvents, e.g. alcohol systems.

The present invention is also not restricted to electrodes that are made from a nickel slurry system. Rather, it is, for example, also suitable for electrodes, which are produced by pressing powder (the so-called “dry-doctoring” systems). Here, the (at least one) structural stabilizer is integrated in the dry powder mixture to be compressed.

### BRIEF DESCRIPTION OF THE DRAWINGS

Embodiments of the present invention are described below with reference to the accompanying drawings. The figures shown in schematic form that are not to scale are as follows:

FIG. 1: a scanning electron micrograph of a reference cathode after about 1000 hours operation in a half cell;

FIG. 2: a scanning electron micrograph of a first embodiment of a cathode after about 1000 hours operation in a half cell;

FIG. 3: a scanning electron micrograph of a second embodiment of a cathode after about 1000 hours operation in a half cell.

### DETAILED DESCRIPTION

An exemplary embodiment of an electrode based on nickel can be prepared as follows:

In principle all nickel powders known to a person skilled in the art can be used as the active substance. Nickel filament powder, preferably of a high purity, is used, such as, for example, the known nickel filament powder of the company Inco and designated Ni-210. This nickel filament powder consists of more or less branched nickel filaments. They form a characteristic three-dimensional chain-like network of very fine nickel particles with a mean diameter of 0.5 to 1.0 μm (maximum diameter: 3.0 μm).

Nickel filaments are used as the stabilizer structure in the embodiments, as they are much more stable than the nickel filament powder when used as the active substance. These nickel filaments can have an average diameter from 2.2 to 3.3 μm (maximum diameter up to 6 μm) and are therefore much thicker and stronger and have a much higher compressive strength than the fine nickel filament powder that serves as the active substance. Suitable nickel filaments from the company Inco are designated as Ni-287.

Inert, heat resistant ceramic fibers are also used as the stabilizer structure in the embodiments. These ceramic fibers can have a length of 500 μm to 1000 μm and/or be 3 μm to 20 μm in diameter.

These ceramic stabilizers are stable, heat resistant and do not change during the conditioning of the electrode and the fuel cell operation. They support the structure of the fine nickel filament powder and maintain it over a long period of time despite high pressure and temperature.

As a pore-forming substance for the (larger) gas transport pores, substances are preferably selected that burn off the residues at the latest when the MCFC fuel cell reaches the operating temperature (about 600° C. to 650° C.). Such pore formers are known to the person skilled in the art, e.g. from DE 10 2006 047 823 A1.

An exemplary formulation of an electrode according to the invention using nickel filaments as a structure stabilizer, such as nickel filament powder (Ni-210 from the company Inco) is as follows:

| | |
|---|---|
| Active substance Ni-A: | 15-25 wt. % |
| Structure stabilizer Ni-B: | |
| Nickel filaments (Ni-287, from the company Inco) | 15-25 wt. % |
| Pore forming substance for | 8-16 wt. % |
| gas transportation and/or reaction spores | |
| Solvent (organic or inorganic) | 10-20 wt. % |
| Organic binding agent | Residue |

An exemplary formulation of an electrode according to the invention using ceramic fibers as the pore stabilizer is as follows:

| | |
|---|---|
| Active substance: | |
| Nickel filament powder (Ni-210 from the company Inco) | 25-45 wt. % |
| Structure stabilizer: | |
| Ceramic fibers C (Rath GmbH) | 5-15 wt. % |
| Pore forming substance for | 8-16 wt. % |
| gas transportation and/or reaction spores | |
| Solvent (organic or inorganic) | 10-20 wt. % |
| Organic binding agent | Residue |

The active substance and structure stabilizer are intimately mixed with one another and the resulting mixture is processed with the remaining components in a known manner to form an electrode slurry. The electrode slurry is applied to an electrode substrate structure (nickel foam from the company Inco) and dried. The application rate is determined by the desired weight of nickel per unit area. The resulting green compacts are processed in a conventional manner to form an MCFC fuel cell. When starting the fuel cell, the organic binding agent and the pore forming substance are burned off, and the nickel of the nickel foam, the active substance and the structure stabilizer is oxidized to form nickel oxide. This is referred to as the conditioning.

Following the above process, cathodes prepared according to the invention with deliberately introduced structural stabilizers were compared with standard cathodes (hereinafter referred to as reference cathodes), which were prepared in the conventional way using an active substance (Ni-210 from the company Inco), pore-formers, solvents and binding agents.

The cathodes prepared according to the invention were compared with a reference cathode in a half-cell test stand. This showed a smaller increase in polarization resistance over time and was particularly evident in the case of the cathode with nickel filaments (Ni-B) as structure stabilizer compared to the reference cathode. This means that this cathode prepared according to the invention showed more stable performance than the reference cathode. The polarization resistance here includes the kinetic resistance and diffusion resistance. Table I shows the results of cathodes prepared according to the invention with different mixing ratios of Ni-A and Ni-B.

TABLE 1

| | Increase of the polarization resistance |
|---|---|
| Mixtures | [mΩ h⁻¹] |
| Ni-A (reference) | 0.0082 |
| Ni-A:Ni-B 9:1 | 0.0107 |
| Ni-A:Ni-B 8:2 | 0.0096 |
| Ni-A:Ni-B 7:3 | 0.0051 |
| Ni-A:Ni-B 6:4 | 0.0019 |
| Ni-A:Ni-B 5:5 | 0.0019 |

The increase in polarization resistance was over a period of 500 h to 1000 h.

It can be clearly seen that, beginning with the mixing ratio of Ni-A:Ni-B of 9:1, the increase in the polarization resistance becomes smaller, until it is at a very small value in the case of a mixing ratio of 6:4 or 5:5. This means that with an increasing proportion of structure stabilizer, the polarization resistance remains constant for longer or increases more slowly than in the case of the reference electrode. Thus the performance remains stable or decreases more slowly during the operation of the fuel cell. Thus, stabilization through stronger and thicker nickel filaments is demonstrated.

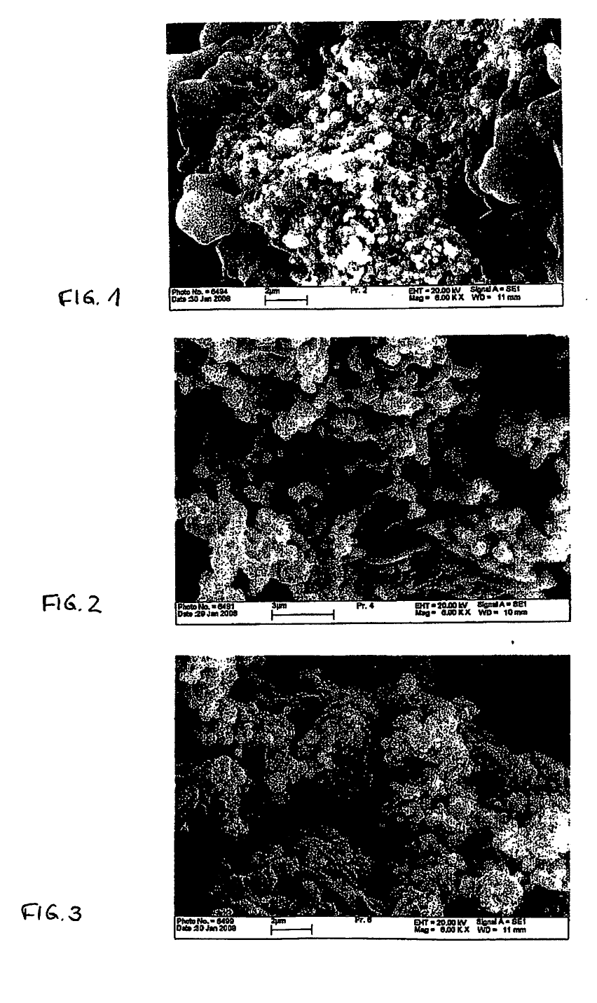

FIGS. 1 through 3 show scanning electron micrographs (hereinafter referred to a SEM-scans) of the cathode structure of a reference cathode (FIG. 1) and two cathodes according to the invention with structural stabilizers in the form of ceramic fibers (FIG. 2) and nickel filaments (FIG. 3) in 6000× magnification. All scans were taken after about 1000 hours of operation in a half-cell.

Small cubes or cube-like structures can be seen on all the scans and represent the nickel oxide. In the case of the reference cathode (FIG. 1), a dense area of nickel oxide cubes is visible. The cubes look like they have been poured in a heap. The filament structure has collapsed, and there are hardly any visible pores. The SEM scan of the cathode using ceramic fibers as a structure stabilizer (FIG. 2), shows many nickel-cubes in a very ordered structure in the form of elongated filaments. The filament structure is relatively well preserved, and there are visible pores. The SEM scan of the cathode structure with nickel filaments as structure stabilizer (FIG. 3) shows that the original characteristic three-dimensional chain-like network of the nickel filament powder used as the active substance, has remained largely intact. Numerous pores can be clearly seen. This scan shows that the cathode according to FIG. 3 still has a very similar appearance to that at the beginning of the operation after 1000 h of operation.

Thus, the stabilization of the pore structure of the cathodes of ceramic fibers or nickel filaments is demonstrated by the SEM scans.

1. An electrode for molten carbonate fuel cell with an electrode structure and an active layer with pores applied to the electrode structure, containing nickel filaments,
characterized in that
the active layer includes at least one structure stabilizer.

2. The electrode according to claim 1,
characterized in that
the structure stabilizer is present in at least one form of nickel filaments that differentiates itself from the nickel filaments of the active substance in a larger form stability.

3. The electrode according to claim 2,
characterized in that
the nickel particles of the nickel filaments of the structure stabilizer are larger in the middle than the nickel particles of the nickel filaments of the active layer.

4. The electrode according to claim 2,
characterized in that
the nickel filaments of the structure stabilizer have nickel particles a minimum 1.5 to 2 times as large as the average diameter of the nickel filaments of the active layer.

5. The electrode according to claim 2,
characterized in that
the nickel filaments of the structure stabilizer have nickel particles with a mean diameter of 2.2 to 3.3 μm.

6. The electrode according to one of the claim 1,
characterized in that
the ratio of active substance to structure stabilizer is 1:1 to 10:1 weight percent.

7. The electrode according to claim 1,
characterized in that
the at least one structural stabilizer is present in the form of ceramic fiber.

8. The electrode according to claim 7,
characterized in that
the ceramic fibers have a diameter of 3 μm to 20 μm and/or a length of 500 μm to 1000 μm.

9. The electrode according to claim 7 or 8,
characterized in that
the ceramic fibers in the mixture for producing the active layer is in a proportion of 1 Vol. % to 20 Vol. % of the mixture.

10. The electrode according to claim 1,
characterized in that
the gas transport pores present in the active layer have a diameter of 5 μm to 50 μm.

11. The electrode according to claim 1,
characterized in that
said reaction pores present in the active layer have a diameter of up to 5 μm.

12. A method for producing an electrode for a molten carbonate fuel cell, comprising preparing a mixture for the production of an active layer which contains at least an active substance containing a nickel filament, at least a pore forming substance, and at least a binding agent, applying the mixture to an electrode structure, heating a resulting green compact so that at least a pore forming substance and at least a binding agent is burned off,
introducing at least a stabilizer structure in the mixture to stabilize the volume and/or size and/or form of the resulting pores during production during conditioning and during operation.

13. The method of claim 12,
wherein that
the structure stabilizer uses nickel filaments and/or ceramic fibers, said the nickel filaments in the structure stabilizer differ from the nickel filaments of the active substance in having a greater form stability.

14. The method of claim 13,
wherein that
nickel particles are used for the nickel filaments of the structure stabilizer, and that they are bigger in size on average than the nickel particles of the nickel filaments of the active layer.

15. The method according to claim 13,
wherein
nickel filaments are used as the structure stabilizer, and said nickel particles are a minimum of 1.5 to 2 times as large as the average diameter of the nickel particles of the active layer.

16. The method according to claim 13,
wherein
the nickel particles used for the nickel filaments of the structure stabilizer have a mean diameter of 2.2 to 3.3 μm.

17. The method according to claim 13
further including
ceramic fibers with a diameter of 3 μm to 20 μm and/or a length of 500 μm to 1000 μm.

18. The method according to claim 13
wherein
a mixture is prepared in which the ratio of active material to the nickel filaments of the structure stabilizer is 1:1 to 10:1 weight percent.

19. The method according to claim 13,
wherein
a mixture is prepared in which the ceramic fibers are in a proportion of 1 Vol. % to 20 Vol. % of the mixture.

20. The method according to claim,
wherein
the powdered nickel filaments are used as the active substance, whereby the nickel particles have an average diameter of 0.5 μm to 1.0 μm.

21. The method according to claim 12,
wherein
the mixture is produced as an electrode slurry or a powder mixture, in particular through pressing powder.

22. The method according to claim 12,
wherein
the mixture is produced as an aqueous or organic system, in particular an alcoholic system.

23. The method according to claim 18, wherein the ratio of nickel filaments of the structure stabilizer is 7:3 wt %.

24. The method according to claim 18 wherein the ration of the nickel filaments of the structure stabilizer is 6:4 wt %.

25. The electrode according to claim 6, wherein the ratio of the active substance to structure stabilizer is 7:3 wt %.

26. The electrode according to claim 6, wherein the ratio of active substance to structural stabilizer is 6:4 wt %.

27. The electrode of claim 11, wherein said reaction pores have a diameter of from 1 μm to 3 μm.
